(19) United States
(12) Patent Application Publication
(10) Pub. No.: US 2021/0131228 A1
(43) Pub. Date: May 6, 2021

(54) MITIGATING LIQUID LOADING IN GAS WELLS

(71) Applicant: Saudi Arabian Oil Company, Dhahran (SA)

(72) Inventor: Saad Al-Driweesh, Udhailiyah (SA)

(21) Appl. No.: 16/668,545

(22) Filed: Oct. 30, 2019

(51) Int. Cl. E21B 36/04; E21B 47/06; H02S 40/44; H05B 1/02

(52) U.S. Cl. CPC E21B 36/04; H05B 1/0244; H02S 40/44; E21B 47/065

(57) ABSTRACT

An assembly includes a photovoltaic cell, an electric heater, and a heat conductor. The photovoltaic cell is configured to convert solar energy into electric power. The electric heater is connected to the photovoltaic cell. The electric heater is configured to generate heat in response to receiving electric power from the photovoltaic cell. The heat conductor is connected to the electric heater. The heat conductor is configured to conduct heat generated by the electric heater to a tubular positioned within a wellbore formed in a subterranean formation.

### TECHNICAL FIELD

This disclosure relates to wellbore operations associated with the production of hydrocarbons.

### BACKGROUND

When natural gas is produced from a well, condensation of liquids may occur as the natural gas expands and cools in transit to the surface. Free liquids, such as oil, water, or both, may also be produced along with the natural gas. Initially, the natural gas may carry such liquids uphole. As reservoir pressure depletes over time, however, the velocity of natural gas in the uphole direction decreases. Eventually, liquids can begin to accumulate in a wellbore, and such liquid loading can inhibit the production of natural gas.

### SUMMARY

In a first general aspect, an assembly includes a photovoltaic cell, an electric heater, and a heat conductor. The photovoltaic cell is configured to convert solar energy into electric power. The electric heater is connected to the photovoltaic cell. The electric heater is configured to generate heat in response to receiving electric power from the photovoltaic cell. The heat conductor is connected to the electric heater. The heat conductor is configured to conduct heat generated by the electric heater to a tubular positioned within a wellbore formed in a subterranean formation.

In a second general aspect, a system includes a tubular, a photovoltaic cell, an electric heater, and a heat conductor. The tubular is positioned within a wellbore formed in a subterranean formation. The photovoltaic cell is configured to convert solar energy into electric power. The electric heater is connected to the photovoltaic cell. The electric heater is configured to generate heat in response to receiving electric power from the photovoltaic cell. The heat conductor connects the electric heater to the tubular. The heat conductor is configured to conduct heat generated by the electric heater to the tubular.

In a third general aspect, solar energy is converted into electric power by a photovoltaic cell. The electric power is delivered to an electric heater. Heat is generated by the electric heater in response to receiving the electric power. The heat from the electric heater is conducted to a tubular by a heat conductor. The tubular is positioned within a wellbore formed in a subterranean formation. Heat is conducted from the electric heater to the tubular, such that the heat is conducted downhole, thereby mitigating liquefaction of production fluid flowing through the tubular.

Implementations of the first, second, and third general aspects may include one or more of the following features.

In some implementations, the assembly (or system) includes a temperature sensor configured to measure a temperature of the tubular.

In some implementations, the assembly (or system) includes a controller communicatively coupled to the electric heater and the temperature sensor. The controller can be configured to receive a temperature signal from the temperature sensor representing the measured temperature of the tubular. The controller can be configured to send a signal to the electric heater to control a rate of heat generation by the electric heater.

In some implementations, the controller is configured to send the signal to the electric heater to adjust the rate of heat generation by the electric heater in response to determining that the measured temperature of the tubular deviates from a target temperature by at least 10%.

In some implementations, the target temperature is 200 degrees Fahrenheit or greater.

In some implementations, conducting the generated heat to the tubular occurs while a production fluid flows to the Earth's surface through the tubular.

In some implementations, the generated heat is conducted to the tubular down to depths, in relation to the Earth's surface, as deep as about 6,000 feet.

In some implementations, the generated heat is conducted to the tubular down to depths, in relation to the Earth's surface, as deep as about 8,000 feet.

In some implementations, a portion of the tubular that is closest to the Earth's surface is maintained at a temperature that is about 200 degrees Fahrenheit or greater.

In some implementations, a temperature of the tubular is measured by a temperature sensor.

In some implementations, a rate of heat generation by the electric heater is adjusted by a controller based on the measured temperature of the tubular.

In some implementations, adjusting the rate of heat generation includes adjusting the rate of heat generation such that a portion of the tubular that is closest to the Earth's surface is maintained at a temperature that is about 200 degrees Fahrenheit or greater.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a schematic diagram of an example well.

FIG. 2A is a schematic diagram of an example assembly that can be implemented to control a temperature of a tubular in the well shown in FIG. 1.

FIG. 2B is a schematic diagram of an example assembly that can be implemented to control a temperature of a tubular in the well shown in FIG. 1.

FIG. 3 is a flow chart of an example method for controlling a temperature of a tubular in the well shown in FIG. 1.

FIG. 4 is an example plot of depth vs. temperature of a tubular in a well.

FIG. 5 is a block diagram of an example computer can be implemented in the apparatus shown in FIG. 2.

### DETAILED DESCRIPTION

This disclosure describes conversion of solar energy into heat energy for use in heating a tubular, for example, a production tubing, positioned within a wellbore formed in a subterranean formation. Heating the production tubing can increase the temperature of wellbore fluids flowing through the tubing and to the surface by a conduction of the heat from the production tubing to the wellbore fluids. The production tubing can be heated via conduction, for example, down to depths of 6,000 to 8,000 feet from the surface of the wellbore. Increasing the temperature of wellbore fluids can mitigate liquid loading in the well, as liquids tend to stay in gaseous form at increased temperatures. Mitigating liquid loading can extend the producing life of the well and can prevent the need for expensive and time-consuming well intervention operations.

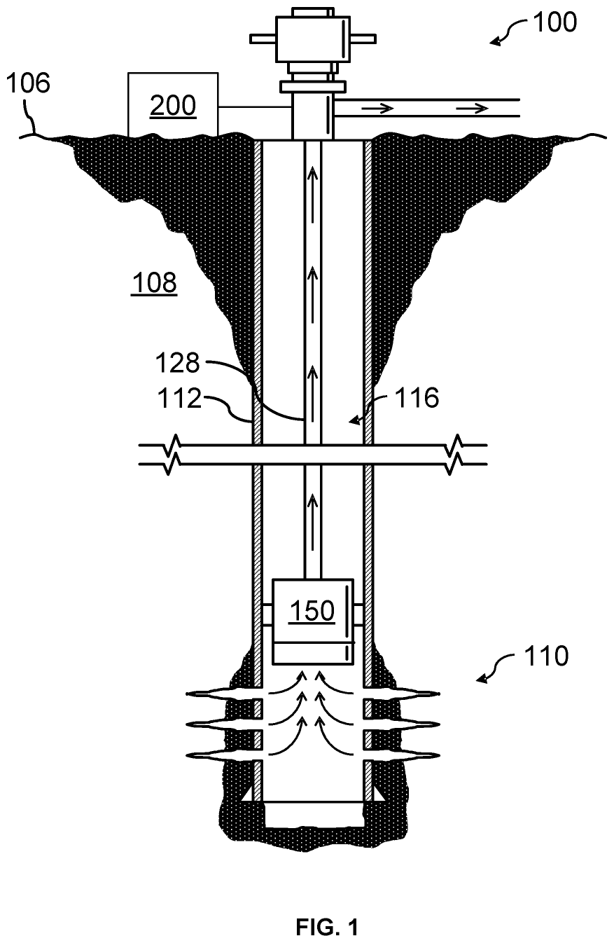

FIG. 1 depicts an example well 100 constructed in accordance with the concepts herein. The well 100 extends from the surface 106 through the Earth 108 to one more subterranean zones of interest 110 (one shown). The well 100 enables access to the subterranean zones of interest 110 to allow recovery (that is, production) of fluids to the surface 106 (represented by flow arrows in FIG. 1) and, in some implementations, additionally or alternatively allows fluids to be placed in the Earth 108. In some implementations, the subterranean zone 110 is a formation within the Earth 108 defining a reservoir, but in other instances, the zone 110 can be multiple formations or a portion of a formation. The subterranean zone can include, for example, a formation, a portion of a formation, or multiple formations in a hydrocarbon-bearing reservoir from which recovery operations can be practiced to recover trapped hydrocarbons. In some implementations, the subterranean zone includes an underground formation of naturally fractured or porous rock containing hydrocarbons (for example, oil, gas, or both). In some implementations, the well can intersect other suitable types of formations, including reservoirs that are not naturally fractured. For simplicity's sake, the well 100 is shown as a vertical well, but in other instances, the well 100 can be a deviated well with a wellbore deviated from vertical (for example, horizontal or slanted), the well 100 can include multiple bores forming a multilateral well (that is, a well having multiple lateral wells branching off another well or wells), or both.

In some implementations, the well 100 is a gas well that is used in producing natural gas from the subterranean zones of interest 110 to the surface 106. While termed a “gas well,” the well need not produce only dry gas, and may incidentally or in much smaller quantities, produce liquid including oil, water, or both. In some implementations, the well 100 is an oil well that is used in producing crude oil from the subterranean zones of interest 110 to the surface 106. While termed an “oil well,” the well not need produce only crude oil, and may incidentally or in much smaller quantities, produce gas, water, or both. In some implementations, the production from the well 100 can be multiphase in any ratio. In some implementations, the production from the well 100 can produce mostly or entirely liquid at certain times and mostly or entirely gas at other times. For example, in certain types of wells it is common to produce water for a period of time to gain access to the gas in the subterranean zone. The concepts herein, though, are not limited in applicability to gas wells, oil wells, or even production wells, and could be used in wells for producing other gas or liquid resources or could be used in injection wells, disposal wells, or other types of wells used in placing fluids into the Earth.

The wellbore of the well 100 is typically, although not necessarily, cylindrical. All or a portion of the wellbore is lined with a tubing, such as casing 112. The casing 112 connects with a wellhead at the surface 106 and extends downhole into the wellbore. The casing 112 operates to isolate the bore of the well 100, defined in the cased portion of the well 100 by the inner bore 116 of the casing 112, from the surrounding Earth 108. The casing 112 can be formed of a single continuous tubing or multiple lengths of tubing joined (for example, threadedly) end-to-end. In FIG. 1, the casing 112 is perforated in the subterranean zone of interest 110 to allow fluid communication between the subterranean zone of interest 110 and the bore 116 of the casing 112. In some implementations, the casing 112 is omitted or ceases in the region of the subterranean zone of interest 110. This portion of the well 100 without casing is often referred to as “open hole.”

The wellhead defines an attachment point for other equipment to be attached to the well 100. For example, FIG. 1 shows well 100 being produced with a Christmas tree attached to the wellhead. The Christmas tree includes valves used to regulate flow into or out of the well 100. The well 100 also includes a system 150 residing in the wellbore, for example, at a depth that is nearer to subterranean zone 110 than the surface 106. The system 150, being of a type configured in size and robust construction for installation within a well 100, can include any type of rotating equipment that can assist production of fluids to the surface 106 and out of the well 100 by creating an additional pressure differential within the well 100. For example, the system 150 can include a pump, compressor, blower, or multi-phase fluid flow aid.

In some implementations, the system 150 can be implemented to alter characteristics of a wellbore by a mechanical intervention at the source. Alternatively, or in addition to any of the other implementations described in this specification, the system 150 can be implemented as a high flow, low pressure rotary device for gas flow in sub-atmospheric wells. Alternatively, or in addition to any of the other implementations described in this specification, the system 150 can be implemented in a direct well-casing deployment for production through the wellbore. Other implementations of the system 150 as a pump, compressor, or multiphase combination of these can be utilized in the well bore to effect increased well production.

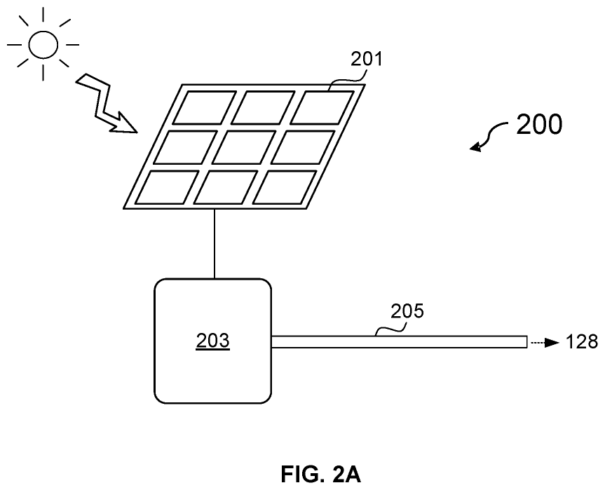

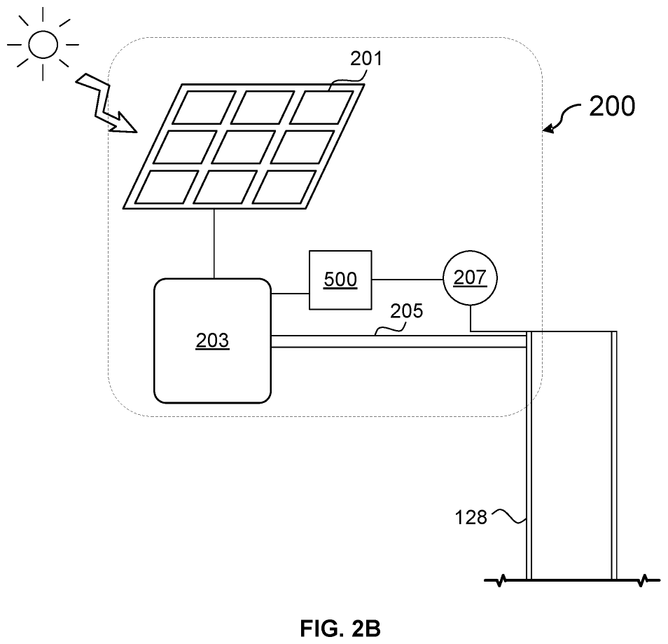

The well 100 can include an assembly 200 that can be implemented to control a temperature of a tubular in the well 100 (for example, the production tubing 128). As shown in FIG. 1, the assembly 200 can reside above the surface 106. The assembly 200 is described in more detail later in relation to FIGS. 2A and 2B.

FIG. 2A shows an example assembly 200 that can be implemented with the well 100. The assembly 200 includes a photovoltaic cell 201, an electric heater 203, and a heat conductor 205. The photovoltaic cell 201 is configured to convert solar energy into electric power. The electric heater 203 is connected to the photovoltaic cell 201. The electric heater 203 is configured to generate heat in response to receiving electric power from the photovoltaic cell 201. The heat conductor 205 is connected to the electric heater 203. The heat conductor 205 is configured to conduct heat generated by the electric heater 203 to a tubular (for example, the production tubing 128) positioned within a wellbore formed in a subterranean formation.

The photovoltaic cell 201 is a device whose electric characteristics, such as current, voltage, or resistance, vary when exposed to light (for example, light from the sun). As shown in FIG. 1, the assembly 200 can include multiple photovoltaic cells to form a module (also known as a solar panel). The photovoltaic cell 201 includes a semiconducting material (for example, silicon) that can absorb photons (for example, from sunlight). The photovoltaic cell 201 can convert solar energy into direct current (DC) electricity. In some implementations, the photovoltaic cell 201 includes an inverter that can convert the power to alternating current (AC).

The electric heater 203 is an electrical device that converts electric power into heat. The electric heater 203 can include a heating element that is an electric resister. As electric current passes through the resister, electrical energy is converted into heat energy. The resister can, for example, be made of nichrome.

The heat conductor 205 is made of a material that is a good conductor of heat. For example, the heat conductor 205 can be made of metal or metal alloy, such as silver, copper, aluminum, gold, iron, steel, brass, bronze, lead, or mercury. The heat conductor 205 can connect the electric heater 205 to a tubular positioned within a wellbore (for example, the production tubing 128 of the well 100). Heat generated by the electric heater 205 can be conducted to the production tubing 128 such that the heat is conducted downhole. The heat conductor 205 can be insulated so that heat dissipation to the environment can be mitigated or eliminated.

In some implementations, the heat conductor 205 can connect to the tubular at multiple points along the tubular. For example, the heat conductor 205 can connect to the tubular at multiple points along the tubular at varying depths. For example, the heat conductor 205 can connect to the tubular at multiple points along a circumference of the tubular at the same depth or at varying depths.

In some implementations, the assembly 200 can include multiple heat conductors identical to the heat conductor 205. Each of the heat conductors can connect the electric heater 205 to the tubular. In some implementations, each of the heat conductors connect to the tubular at multiple points along the tubular at varying depths. In some implementations, each of the heat conductors connect to the tubular at multiple points along the circumference of the tubular at the same depth or at varying depths.

Production tubing 128 is typically made of metal (for example, steel), and any heat conducted to the production tubing 128 can also be conducted downhole through the production tubing 128. As mentioned previously, natural gas can expand and cool as it flows up the production tubing 128 to the surface 106, and such cooling can result in condensation of liquids (liquefaction). Conducting heat downhole through the production tubing 128 can mitigate the cooling of the production fluid flowing through the production tubing 128, thereby mitigating liquefaction of production fluid. In some cases, conducting heat downhole through the production tubing 128 can vaporize liquid (such as water) that may be entrained with the flow of production fluid, which further mitigates liquid loading in the well 100.

The electric heater 203 and heat conductor 205 can be cooperatively configured to maintain a portion of the production tubing 128 that is closest to the surface 106 at a temperature that is about 200 degrees Fahrenheit (° F.) or greater (for example, about 250° F., about 300° F., or about 350° F.). The electric heater 203, heat conductor 205, and the production tubing 128 can be cooperatively configured to conduct heat to the production tubing 128 down the depths, in relation to the surface 106, as deep as about 100 feet, about 500 feet, about 1,000 feet, about 1,500 feet, about 2,000 feet, about 2,500 feet, about 3,000 feet, about 3,500 feet, about 4,000 feet, about 4,500 feet, about 5,000 feet, about 5,500 feet, about 6,000 feet, about 6,500 feet, about 7,000 feet, about 7,500 feet, or about 8,000 feet. In some cases, the desired depth of heat conduction can depend on a total depth of the well 100. For example, for a well having a total depth ranging from about 13,000 feet to about 14,000 feet, the electric heater 203 and heat conductor 205 can be cooperatively configured to conduct heat to the production tubing 128 down to depths as deep as about 6,000 feet. Alternatively or in addition, the desired depth of heat conduction can depend on a depth at which the temperature of the natural gas and the corresponding flow velocity in the uphole direction decreases to a level that heating the natural gas to increase or maintain the flow velocity is necessary to prevent liquid loading.

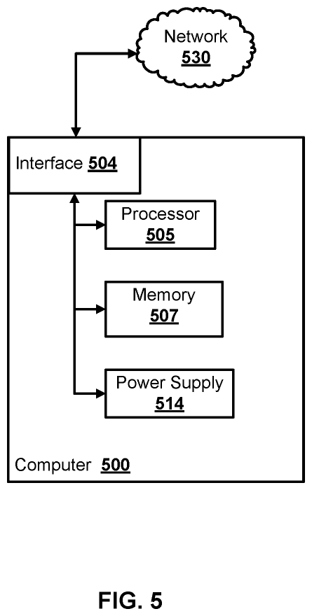

FIG. 2B shows an example assembly 200 that can be implemented with the well 100. The assembly 200 of FIG. 2B can include the same components as the assembly 200 of FIG. 2A (photovoltaic cell 201, electric heater 203, and heat conductor 205). As shown in FIG. 2B, the assembly 200 can include additional components. For example, the assembly 200 can include a temperature sensor 207 and a controller 500. The temperature sensor 207 can be connected to the tubular that is being heated (production tubing 128) and can be configured to measure a temperature of the tubular. The controller 500 can be, for example, a computer, which is also described in more detail later with respect to FIG. 5.

The controller 500 can be communicatively coupled to the electric heater 203 and the temperature sensor 207. The controller 500 can be configured to receive a temperature signal from the temperature sensor 207 that represents the measured temperature of the tubular. The controller 500 can be configured to send a signal to the electric heater 203 to control a rate of heat generation by the electric heater 203. The controller 500 can be configured to send the signal to the electric heater 203 to adjust the rate of heat generation by the electric heater 203 based on the temperature signal received from the temperature sensor 207. For example, the controller 500 can be configured to send the signal to the electric heater 203 to adjust the rate of heat generation in response to determining that the measured temperature of the tubular deviates from a target temperature by at least 5% or at least 10%.

For example, for a target temperature of 200° F., the controller 500 can send a signal to the electric heater 203 to decrease the rate of heat generation in response to determining that the measured temperature of the production tubing 128 is 220° F. or greater. As another example, for a target temperature of 200° F., the controller 500 can send a signal to the electric heater 203 to increase the rate of heat generation in response to determining that the measured temperature of the production tubing 128 is 190° F. or less.

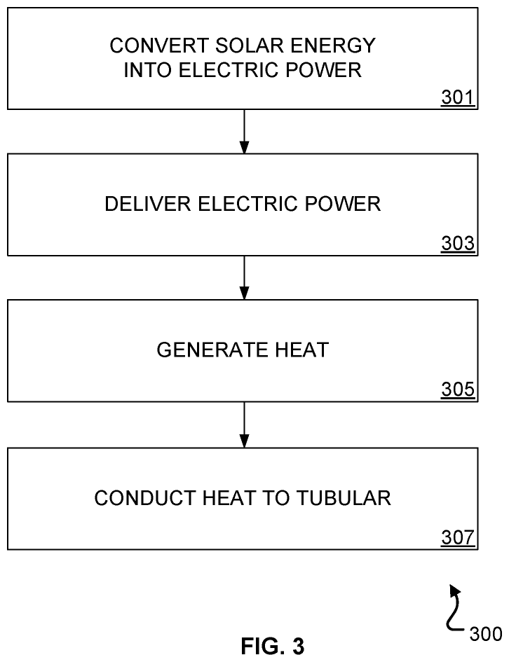

FIG. 3 is a flow chart of an example method 300 which can be implemented to control a temperature of a tubular positioned in a well (for example, the production tubing 128 positioned in the well 100). The assembly 200 can be used to implement method 300. At step 301, solar energy is converted into electric power by a photovoltaic cell (for example, the photovoltaic cell 201). At step 303, the electric power is delivered to an electric heater (for example, the electric heater 203). At step 305, heat is generated by the electric heater 203 in response to receiving the electric power from the photovoltaic cell 201. At step 307, heat is conducted from the electric heater 203 to the tubular by a heat conductor (for example, the heat conductor 205). Conducting heat to the tubular at step 307 conducts heat downhole, thereby mitigating liquefaction of production fluid flowing through the tubular.

Heat can be conducted to the tubular at step 307 down to depths, in relation to the surface 106, as deep as about 100 feet, about 500 feet, about 1,000 feet, about 1,500 feet, about 2,000 feet, about 2,500 feet, about 3,000 feet, about 3,500 feet, about 4,000 feet, about 4,500 feet, about 5,000 feet, about 5,500 feet, about 6,000 feet, about 6,500 feet, about 7,000 feet, about 7,500 feet, or about 8,000 feet. In some implementations, a portion of the tubular that is closest to the surface 106 can be maintained at a temperature that is about 200° F. or greater (for example, about 250° F., about 300° F., or about 350° F.).

In some implementations, a temperature of the tubular can be measured by a temperature sensor (for example, the temperature sensor 207). In some implementations, a rate of heat generation by the electric heater 203 at step 305 can be adjusted by a controller (for example, the controller 500) based on the measured temperature of the tubular. For example, the controller 500 can send a signal to the electric heater 203 to adjust the rate of heat generation in response to determining that the measured temperature of the tubular deviates from a target temperature by at least 5% or at least 10%.

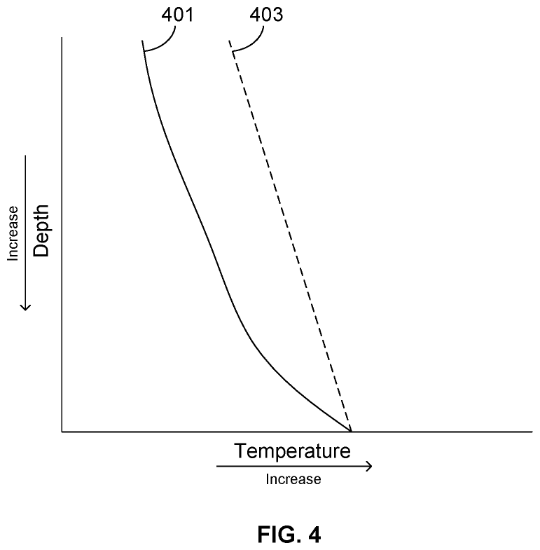

FIG. 4 is an example plot of depth vs. temperature of a tubular positioned in a well (for example, the production tubing 128 of the well 100). Curve 401 shows a relationship of temperature and depth of a tubular in which temperature is not being controlled as production fluid is being produced through the tubular. Curve 403 shows a relationship of temperature and depth of a tubular in which temperature is being controlled (for example, by the assembly 200) as production fluid is being produced through the tubular. Implementing the assembly 200 with the well 100 can keep the tubular at hotter temperatures at decreasing depths, thereby mitigating the condensation of liquid in the production fluid flowing up to the surface 106 through the tubular.

FIG. 5 is a block diagram of an example computer 500 used to provide computational functionalities associated with described algorithms, methods, functions, processes, flows, and procedures, as described in this specification, according to an implementation. The illustrated computer 500 is intended to encompass any computing device such as a server, desktop computer, laptop/notebook computer, one or more processors within these devices, or any other suitable processing device, including physical or virtual instances (or both) of the computing device. Additionally, the computer 500 can include a computer that includes an input device, such as a keypad, keyboard, touch screen, or other device that can accept user information, and an output device that conveys information associated with the operation of the computer 500, including digital data, visual, audio information, or a combination of information.

The computer 500 can include an interface 504. Although illustrated as a single interface 504 in FIG. 5, two or more interfaces 504 may be used according to particular needs, desires, or particular implementations of the computer 500. The computer 500 can be communicably coupled with a network 530. The interface 504 is used by the computer 500 for communicating with other systems that are connected to the network in a distributed environment. Generally, the interface 504 comprises logic encoded in software or hardware (or a combination of software and hardware) and is operable to communicate with the network. More specifically, the interface 504 may comprise software supporting one or more communication protocols associated with communications such that the network or interface's hardware is operable to communicate physical signals within and outside of the illustrated computer 500.

The computer 500 includes a processor 505. Although illustrated as a single processor 505 in FIG. 5, two or more processors may be used according to particular needs, desires, or particular implementations of the computer 500. Generally, the processor 505 executes instructions and manipulates data to perform the operations of the computer 500 and any algorithms, methods, functions, processes, flows, and procedures as described in this specification.

The computer 500 also includes a memory 507 that can hold data for the computer 500 or other components (or a combination of both) that can be connected to the network. Although illustrated as a single memory 507 in FIG. 5, two or more memories 507 (of the same or combination of types) can be used according to particular needs, desires, or particular implementations of the computer 500 and the described functionality. While memory 507 is illustrated as an integral component of the computer 500, memory 507 can be external to the computer 500. The memory 507 can be a transitory or non-transitory storage medium.

The memory 507 stores computer-readable instructions executable by the processor 505 that, when executed, cause the processor 505 to perform operations, such as receiving a temperature signal from a temperature sensor (for example, the temperature sensor 207) that represents the measured temperature of a tubular (for example, the production tubing 128), sending a signal to an electric heater (for example, the electric heater 203) to control a rate of heat generation by the electric heater, and determining that the measured temperature of the tubular deviates from a target temperature by at least 5% or at least 10%.

The computer 500 can also include a power supply 514. The power supply 514 can include a rechargeable or non-rechargeable battery that can be configured to be either user- or non-user-replaceable. The power supply 514 can be hard-wired. There may be any number of computers 500 associated with, or external to, a computer system containing computer 500, each computer 500 communicating over the network. Further, the term “client,” “user,” “operator,” and other appropriate terminology may be used interchangeably, as appropriate, without departing from this specification. Moreover, this specification contemplates that many users may use one computer 500, or that one user may use multiple computers 500.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. An assembly, comprising:
a photovoltaic cell configured to convert solar energy into electric power;
an electric heater connected to the photovoltaic cell, the electric heater configured to generate heat in response to receiving electric power from the photovoltaic cell; and
a heat conductor connected to the electric heater and configured to conduct heat generated by the electric heater to a tubular positioned within a wellbore formed in a subterranean formation.

2. The assembly of claim 1, comprising a temperature sensor configured to measure a temperature of the tubular.

3. The assembly of claim 2, comprising a controller communicatively coupled to the electric heater and the temperature sensor, the controller configured to receive a temperature signal from the temperature sensor representing the measured temperature of the tubular, the controller configured to send a signal to the electric heater to control a rate of heat generation by the electric heater.

4. The assembly of claim 3, wherein the controller is configured to send the signal to the electric heater to adjust the rate of heat generation by the electric heater in response to determining that the measured temperature of the tubular deviates from a target temperature by at least 10%.

5. The assembly of claim 4, wherein the target temperature is 200 degrees Fahrenheit or greater.

6. A system, comprising:
a tubular positioned within a wellbore formed in a subterranean formation;
a photovoltaic cell configured to convert solar energy into electric power;
an electric heater connected to the photovoltaic cell, the electric heater configured to generate heat in response to receiving electric power from the photovoltaic cell; and
a heat conductor connecting the electric heater to the tubular, the heat conductor configured to conduct heat generated by the electric heater to the tubular.

7. The system of claim 6, comprising a temperature sensor configured to measure a temperature of the tubular.

8. The system of claim 7, comprising a controller communicatively coupled to the electric heater and the temperature sensor, the controller configured to receive a temperature signal from the temperature sensor representing the measured temperature of the tubular, the controller configured to send a signal to the electric heater to control a rate of heat generation by the electric heater.

9. The system of claim 8, wherein the controller is configured to send the signal to the electric heater to adjust the rate of heat generation by the electric heater in response to determining that the measured temperature of the tubular deviates from a target temperature by at least 10%.

10. A method, comprising:
converting, by a photovoltaic cell, solar energy into electric power;
delivering the electric power to an electric heater;
generating, by the electric heater, heat in response to receiving the electric power; and
conducting, by a heat conductor, the heat from the electric heater to a tubular positioned within a wellbore formed in a subterranean formation, such that the heat is conducted downhole, thereby mitigating liquefaction of production fluid flowing through the tubular.

11. The method of claim 10, wherein conducting the generated heat to the tubular occurs while a production fluid flows to the Earth's surface through the tubular.

12. The method of claim 11, wherein the generated heat is conducted to the tubular down to depths, in relation to the Earth's surface, as deep as about 6,000 feet.

13. The method of claim 12, wherein the generated heat is conducted to the tubular down to depths, in relation to the Earth's surface, as deep as about 8,000 feet.

14. The method of claim 11, comprising maintaining a portion of the tubular that is closest to the Earth's surface at a temperature that is about 200 degrees Fahrenheit or greater.

15. The method of claim 11, comprising measuring, by a temperature sensor, a temperature of the tubular.

16. The method of claim 15, comprising adjusting, by a controller, a rate of heat generation by the electric heater based on the measured temperature of the tubular.

17. The method of claim 16, wherein adjusting the rate of heat generation comprises adjusting the rate of heat generation such that a portion of the tubular that is closest to the Earth's surface is maintained at a temperature that is about 200 degrees Fahrenheit or greater.
